(19) United States
(12) Patent Application Publication
(10) Pub. No.: US 2014/0029493 A1
(43) Pub. Date: Jan. 30, 2014

(54) Wireless Communication Interworking Function

(71) Applicants: Gustav Gerald Vos, Surrey (CA); Richard Thomas Kavanaugh, Encinitas, CA (US)

(72) Inventors: Gustav Gerald Vos, Surrey (CA); Richard Thomas Kavanaugh, Encinitas, CA (US)

(73) Assignee: SIERRA WIRELESS, INC., Richmond (CA)

(21) Appl. No.: 13/558,824

(22) Filed: Jul. 26, 2012

(51) Int. Cl. H04W 80/00

(52) U.S. Cl. 370/310

(57) ABSTRACT

A method and apparatus facilitate data communication between a first device and a second device, such as an application server or Internet portal and a wireless terminal. A wireless link between devices supports communication via plural protocols, such as SMS and TCP/IP over GPRS. An interworking function (IWF) allows communication using native protocols, such as TCP/IP, but when appropriate (e.g. for small data transactions), translates messages to another protocol, such as SMS, for efficiency purposes. The IWF intercepts and responds to packets generated by the first device using the first protocol, as required. The IWF optionally selects a new protocol and generates and forwards packets, representative of the intercepted packets, to the second device. Protocol selection and/or turning the interworking function on/off can be performed dynamically based on efficiency criteria. The IWF may intercept packets before traversal of the wireless link, and may optionally reside in the wireless terminals.

### CROSS-REFERENCE TO RELATED APPLICATIONS

This is the first application filed for the present technology.

### FIELD OF THE TECHNOLOGY

The present technology pertains in general to wireless data communications and in particular to a protocol-to-protocol interworking function for use in a wireless communication network.

### BACKGROUND

Various wireless network technologies, such as cellular communication technologies, include one or more mechanisms by which data can be communicated between a wireless terminal and another endpoint such as a server. These mechanisms can be used to enable client-server type applications running on wireless terminals and serviced by an external Internet server, for example.

General Packet Radio Service (GPRS) is a service offered in various cellular GSM networks. GPRS currently supports Internet Protocol (IP) communications. GPRS also supports Short Messaging Service (SMS) and Multimedia Messaging Service (MMS), as well as services using the Wireless Application. Protocol (WAP), among others. When a terminal wants to use GPRS, for example for IP communications, it generally attaches and activates a Packet Data Protocol (PDP) context, in order to establish a data record which includes the terminal's IP address, International Mobile Subscriber Identity (IMSI), and an allocated Tunnel Endpoint ID. With the PDP context established, IP packets can be tunneled to and from the terminal. However, when computing applications only require short or intermittent data communications, signalling overhead using many GPRS functions can be high, leading to inefficient use of network resources. For example, attaching and establishing a PDP context utilizes a certain amount of resource overhead. Transmission Control Protocol (TCP) control packets such as SYN, ACK and FIN packets, and their responses, are also required when establishing a TCP connection. Thus, to communicate a few Bytes of data may require an overhead of 240 Bytes of data in 6 packets, merely for TCP control.

SMS is a standardized service by which text-based messages can be sent to and from wireless terminals. SMS messages are about 140 Bytes long or less. However, several SMS messages can be concatenated to form a longer message. The specification allows for up to 256 messages to be concatenated in this way. SMS messages are sent via a store and forward mechanism integrated into the wireless network. SMS messages can be sent between wireless terminals, or can be sent to and from other devices such as computers via a gateway. For example, an email to a predetermined address may be translated into an SMS message and forwarded to an associated wireless terminal. However, SMS implementations are generally optimized for communicating human-readable messages.

Therefore there is a need for a method and apparatus for facilitating data communication over a wireless link that is not subject to one or more limitations of the prior art.

This background information is provided for the purpose of making known information believed by the applicant to be of possible relevance to the present technology. No admission is necessarily intended, nor should be construed, that any of the preceding information constitutes prior art against the present technology.

### SUMMARY OF THE TECHNOLOGY

An object of the present technology is to provide for a protocol-to-protocol interworking function for use in a wireless communication network. In accordance with an aspect of the present technology, there is provided a method for facilitating data communication between a first device and a second device, the first device and the second device communicatively coupled at least in part via a wireless communication link, wherein the wireless communication link is capable of supporting said data communication via a plurality of protocols, the method comprising: intercepting one or more packets generated by a communication process operating on the first device, the packets formatted in accordance with a first protocol of the plurality of protocols; communicating one or more responses to one or more intercepted packets, if required, in accordance with the first protocol; and communicating with the second device or a representative thereof in accordance with a second protocol selected from the plurality of protocols, wherein said communication with the second device is representative of an intended communication corresponding to the one or more intercepted packets.

In accordance with another aspect of the present technology, there is provided an apparatus configured to facilitate data communication between a first device and a second device, the first device and the second device communicatively coupled at least in part via a wireless communication link, wherein the wireless communication link is capable of supporting said data communication via a plurality of protocols, the apparatus comprising: a first interface module configured to intercept one or more packets generated by a communication process operating on the first device, the packets formatted in accordance with a first protocol of the plurality of protocols; a second interface module configured for communication with the second device or a representative thereof; and an interworking function module configured to: manage communication of one or more responses to the one or more intercepted packets, if required, in accordance with the first protocol, the one or more responses communicated via the first interface module; and manage communication with the second device or the representative thereof in accordance with a second protocol selected from the plurality of protocols, wherein said communication with the second device or the representative thereof is representative of an intended communication corresponding to the one or more intercepted packets, said communication with the second device performed via the second interface module.

In accordance with another aspect of the present technology, there is provided a method for facilitating data communication between a first device and a second device, the first device and the second device communicatively coupled at least in part via a wireless communication link, wherein the wireless communication link is capable of supporting said data communication via a first protocol and a second protocol, the method comprising: intercepting one or more packets generated by a communication process operating on the first device, the packets formatted in accordance with the first protocol, the packets intercepted at a first location prior to traversal of the wireless communication link; generating, at the first location and in response to the one or more intercepted packets, one or more response packets in accordance with the first protocol; communicating the one or more response packets to the communication process; generating, at the first location and in response to the intercepted packets, one or more representative packets in accordance with the second protocol, the representative packets comprising content corresponding to content of the intercepted packets; and transmitting the representative packets via the wireless communication link, the representative packets addressed to the second device.

In accordance with another aspect of the present technology, there is provided a computer program product comprising a computer readable memory storing computer executable instructions thereon that when executed by a one or more operatively coupled computers, perform operations for facilitating data communication between a first device and a second device, the first device and the second device communicatively coupled at least in part via a wireless communication link, wherein the wireless communication link is capable of supporting said data communication via a plurality of protocols, the operations comprising: intercepting one or more packets generated by a communication process operating on the first device, the packets formatted in accordance with a first protocol of the plurality of protocols; communicating one or more responses to one or more intercepted packets, if required, in accordance with the first protocol; and communicating with the second device or a representative thereof in accordance with a second protocol selected from the plurality of protocols, wherein said communication with the second device is representative of an intended communication corresponding to the one or more intercepted packets.

### BRIEF DESCRIPTION OF THE FIGURES

These and other features of the technology will become more apparent in the following detailed description in which reference is made to the appended drawings.

FIG. 1 illustrates a method for facilitating data communication provided in accordance with embodiments of the present technology.

FIG. 2 illustrates an apparatus for facilitating data communication provided in accordance with embodiments of the present technology.

FIG. 3 illustrates a communication network, within the context of which some embodiments of the present technology operate.

FIG. 4 illustrates an example message flow for a terminal device sending a small TCP packet and then a large TCP packet to a portal, such as an Internet portal, in accordance with embodiments of the present technology.

FIG. 5 illustrates an example message flow for a portal sending a small TCP packet and then a large TCP packet to a terminal, in accordance with embodiments of the present technology.

FIG. 6 illustrates an example message flow, including a failed delivery notification, in accordance with embodiments of the present technology.

FIG. 7 illustrates example message flows from and to a terminal device, when no client-side SMS-IP IWF is present, in accordance with embodiments of the present technology.

FIG. 8 illustrates a diagram of a TCP/IP header with information to be included in SMS packets highlighted, in accordance with embodiments of the present technology.

### DETAILED DESCRIPTION OF THE TECHNOLOGY

### Definitions

The term “channel” is used herein in a general sense to refer to various means by which data can be communicated between devices. A channel can involve communication via one or more physical media, modulation frequencies and schemes, coding schemes, protocols, and the like. A channel may correspond to a predetermined stack of inter-second protocols, for example in accordance with the OSI model. Different channels may be defined partially or completely by the different protocols associated therewith.

The term “protocol” is used herein to refer to a protocol or stack of protocols by which devices in a network can communicate. A protocol or stack thereof may, for example, be related to one or more protocol layers of the OSI model. Exemplary protocols are the Short Messaging Service (SMS) protocol, the TCP protocol, the IP protocol, the Hypertext Transfer Protocol (HTTP) protocol, and the User Datagram Protocol (UDP) protocol.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this technology belongs.

The present technology relates to a protocol-to-protocol interworking function for use in a wireless communication network, such as a Short Messaging Service (SMS) to Internet Protocol (IP) or TCP/IP interface. In accordance with an aspect of the present technology, there is provided a method for facilitating data communication between a first device, for example a terminal/server who is the sender and a second device for example a terminal or server who is the receiver. The first device and the second device are communicatively coupled at least in part via a wireless communication link, for example enabled by a cellular network. The wireless communication link is capable of supporting data communication via a plurality of protocols, such as SMS and TCP/IP over GPRS.

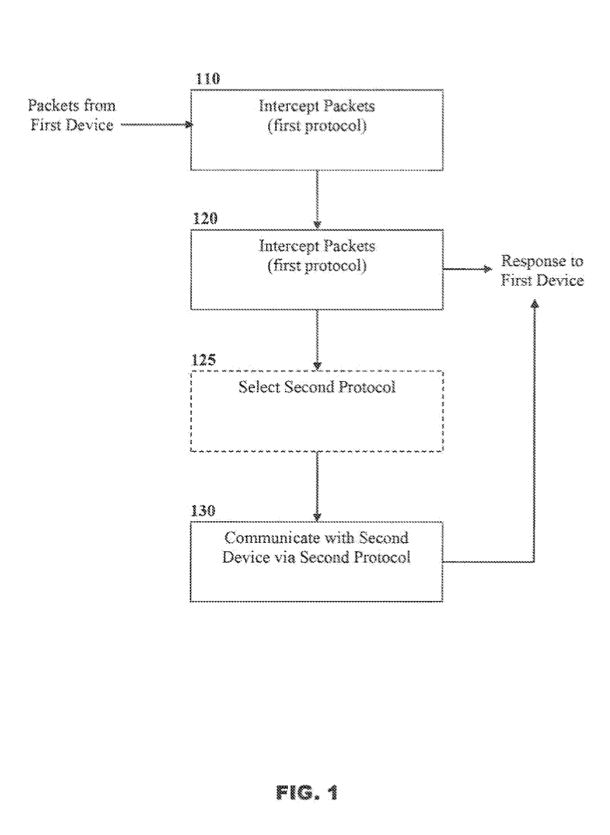

Referring to FIG. 1, the method comprises intercepting 110 one or more packets generated by a communication process operating on the first device. The intercepted packets have been formatted in accordance with a first protocol, for example TCP/IP, of the plurality of protocols. The method further comprises communicating 120 one or more responses to one or more intercepted packets, if required, in accordance with the first protocol. The method further optionally comprises selecting 125 a second protocol from the plurality of protocols in response to the interception of the one or more packets. The method further comprises communicating 130 with the second device in accordance with a second protocol, for example SMS or TCP/IP, selected from the plurality of protocols. Communication with the second device may, in some embodiments, be performed by way of communication with a representative, such as another interworking function. Communicating 120 the one or more responses may be, at least in part, contingent upon communication 130 with the second device. Communication with the second device is representative of an intended communication corresponding to the one or more intercepted packets. Thus, for example, the interworking function communicates the intention of the intercepted packets but, possibly, via another protocol. The method may be performed by a computer or by a plurality of computers communicatively and operatively coupled to each other.

Another aspect of the present technology provides a computer program product comprising a computer readable memory storing computer executable instructions thereon that when executed by a computer perform the method as described above and/or a method as described elsewhere herein.

In accordance with yet another aspect of the present technology there is provided an apparatus configured to facilitate data communication between a first device and a second device, the first device and the second device communicatively coupled at least in part via a wireless communication link, wherein the wireless communication link is capable of supporting said data communication via a plurality of protocols. The apparatus may be provided in a server or other device of a wireless network infrastructure, or as a functional module within a wireless terminal, such as a mobile phone, laptop computer, or automated machine-type device such as a wireless meter, sensor, or actuator. In some embodiments the apparatus may be provided in a combination of such devices.

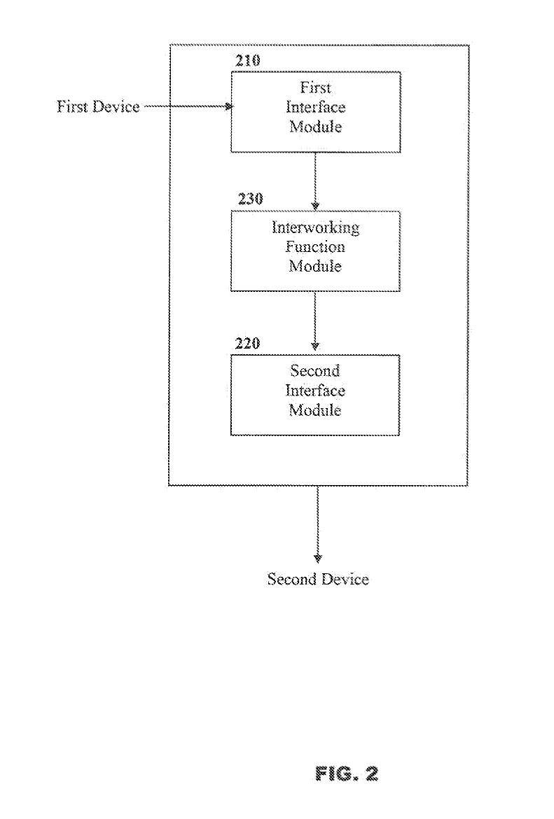

Referring to FIG. 2, the apparatus comprises a first interface module 210, a second interface module 220, and an interworking function module 230. The first interface module is configured to intercept one or more packets generated by a communication process operating on the first device. The intercepted packets have been formatted, by the first device, in accordance with a first protocol of the plurality of protocols. The second interface module is configured for communication with the second device or a representative thereof. The interworking function module is operatively coupled to the first and second interface modules, and is configured to manage communication of one or more responses to the one or more intercepted packets, if required. Communication of the one or more responses is managed in accordance with the first protocol, and the one or more responses are communicated via the first interface module. The interworking function is optionally configured to select a second protocol from the plurality of protocols in response to the interception of the one or more packets. The interworking function module is further configured to manage communication with the second device, or the representative thereof, in accordance with a second protocol selected from the plurality of protocols. Communication with the second device or the representative thereof is representative of an intended communication corresponding to the one or more intercepted packets. Communication with the second device is performed via the second interface module.

### General Discussion

Many applications, such as machine-to-machine (M2M) applications and client-server type applications associated with devices such as smartphones, send small data packets. Instead of using a protocol with high overhead, such as a relatively high-overhead connection-oriented protocol (TCP, for example), embodiments of the present technology allows another protocol, such as SMS, to be used when such use would be more efficient. SMS may be more efficient than TCP/IP as it is implemented over cellular networks such as GSM. However, SMS is not IP based, but rather the routing is based on the Mobile Station Integrated Services Digital Network (MSISDN) number. Most applications and portals developers would prefer to deal with IP based protocols such as HTTP, TCP and/or UDP since there are pre-built stacks for these protocols readily available. Embodiments of the present technology therefore provide for an interworking function which interacts with existing protocols, so that applications can be developed around IP based protocols, which are then translated by the interworking function as required.

Embodiments of the present technology comprise allowing communication between an IP portal and an application to use native IP protocols (for example IPv4 or IPv6, HTTP, TCP, UDP), but when appropriate, (e.g. for small data transactions) using an SMS-IP interworking function (IWF) to communicate via SMS messaging. This can facilitate more efficient use of communication resources, and can be enabled by selecting a more efficient protocol for a given communication session.

Embodiments of the present technology leverage the existence of a plurality of different communication channels in a wireless network, each of which is capable of transmitting data to and from wireless terminals. For example, a wireless network may support both a TCP/IP channel enabled by GPRS and an SMS channel for data transmission. Each of the plurality of communication channels operates using a different protocol, with different characteristics. Embodiments of the present technology are directed, at least in part, to selecting and using, in a predetermined manner, one or more communication channels from the plurality of communication channels. The selection may be based on characteristics of the pending data communication as well as characteristics of the communication channels. In some embodiments, the most efficient communication channel for a particular data communication session can be selected. For example, an SMS channel may be selected for exchanging a relatively small number of short packets, while an IP channel may be selected for exchanging larger numbers of packets and/or larger packets. Channel selection can be one-time or it can be ongoing, such that the channel may change during the communication.

While the present technology is presented in terms of SMS and IP or TCP/IP supported by GPRS or a similar packet transmission service, it is recognized and expected that the present technology may also be applied to other types of channels or protocols, currently defined or to be defined in future. In addition, it is recognized and expected that SMS may be replaced by another suitable message delivery mechanism, typically an efficient and small message delivery mechanism. In some embodiments, Unstructured Supplementary Service Data (USSD) may be used as a message delivery mechanism. In some embodiments, a messaging scheme over T5 as disclosed in Section 4.2 of 3GPP TS 23.682 “Architecture enhancements to facilitate communications with packet data networks and applications,” 3^{rd} Generation Partnership Project; v 11.0.0, March 2012 may be used.

Embodiments of the present technology provide a transparent communication service via an interworking function. The interworking function can operate on the terminal side and/or the server side of a wireless communication network. Transparency is achieved in that communication processes which are mediated via the interworking function need not necessarily be aware of the presence of the interworking function. Advantageously, some embodiments of the present technology can be achieved in an existing network without substantial modification to other network elements.

In some embodiments, end-to-end connectivity is provided. For example, an interoperating pair of interworking functions may be configured to communicate acknowledgements and/or negative acknowledgements between the first and second devices. The first and second devices may communicate these acknowledgements (or other control packets) in accordance with a first protocol. The acknowledgements or other control packets are translated by the interworking functions into representative messages formatted in accordance with a second protocol. A representative message may represent an aggregate of control packets, or a command to initiate a control transaction. End-to-end connectivity may be configured such that end-to-end acknowledgements are only sent by the interworking function once a message is delivered to its end destination, or a target representative such as a portal. Intermediate acknowledgements may also be sent, for example between interworking functions, but these may not result in an end-to-end acknowledgement communicated to the message originator.

In embodiments, end-to-end connectivity also comprises conveying routing information, such as IP addresses and port numbers, via the representative packets as embedded information, as required. For example, a first IWF may embed routing information into a message (from a first device) sent to a second IWF, so that the second IWF can reconstruct packets in accordance with the originating protocol, for sending to the second device.

In some embodiments, the interworking function is configured to intercept data packets sent to and/or from a device coupled to the wireless communication network and to translate the data packets from one protocol to another when required. The translated packets are forwarded to their intended destination in their new format. The interworking function is further configured to appear, to one or more endpoints of the communication, as an endpoint device operating in accordance with a predetermined protocol. For example, the interworking function may be configured to transmit control packets (such as TCP ACK packets) as required, to add appropriate header information to data packets, and to embed data into the data packets in a manner which accords with the predetermined protocol.

In some embodiments, the interworking function may be used to intelligently switch between available communication channels or protocols without requiring devices or applications communicating via the interworking function to be aware of the occurrence of such switching. The intelligent switching may be performed in a predetermined manner so as to make efficient use of the available communication channels.

In some embodiments, the interworking function can, in one mode of operation, simply forward the intercepted packets as they are received, without protocol translation, and also pass along any responses to these forwarded packets. In this mode, the present technology operates in a “null” mode, insofar as it has no substantial effect on communication. However, the interworking function is capable of switching to another mode in which protocol translation is active, should said other mode be deemed more efficient.

### Exemplary Communication Network

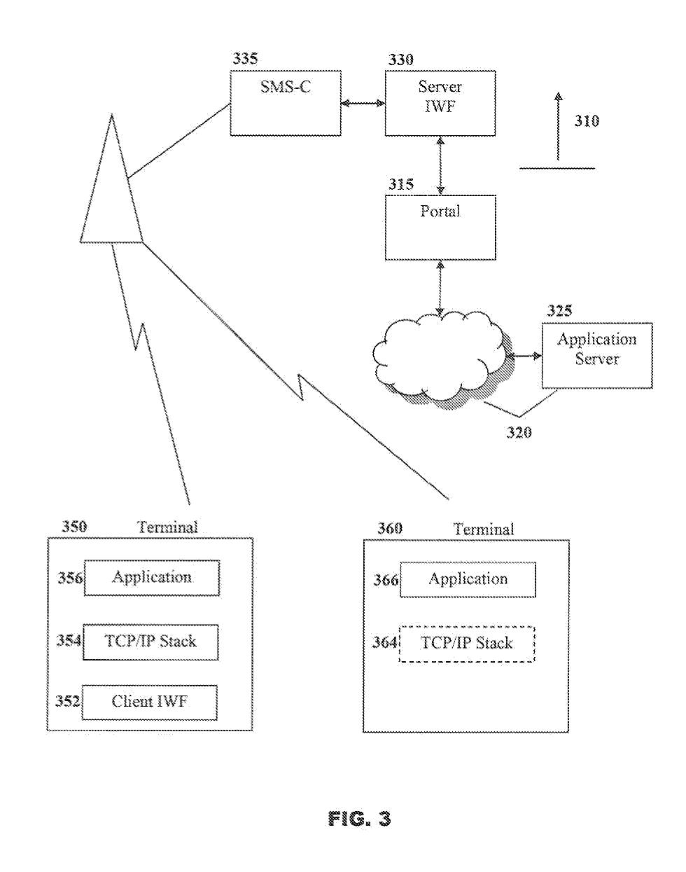

FIG. 3 illustrates a communication network, within the context of which embodiments of the present technology operate. Communicative coupling of devices within the network is illustrated. The communication network comprises a wireless network 310 operatively coupled to an external network 320, such as the Internet, via a portal 315, which may be part of a wireless network server or other appropriate networking equipment.

The external network comprises an application server 325 in communication with the portal 315. The wireless network 310 comprises a server-side interworking function (IWF) apparatus 330 operatively coupled to the portal. The server-side IWF apparatus 330 is configured for facilitating data communication as described herein, and may act as a representative of the application server 325.

The exemplary communication network further comprises a Short Message Service Center (SMS-C) 335, operatively coupled to the server-side IWF apparatus 330. In some embodiments, one or more of the SMS-C 335, the server-side IWF apparatus 330, and the portal 315 may be provided as functional modules of the same computing device or server. The SMS-C 335 operates to receive, process, and forward SMS messages to and from wireless terminals within the wireless network 310, as would be readily understood by a worker skilled in the art.

The exemplary communication network further comprises one or more Base Transceiver Stations (BTS) 340 and one or more wireless terminals 360, 350. Bidirectional wireless communication between the BTS 340 and the wireless terminals 350, 360, as well as the SMS-C 335 is performed as would be readily understood by a worker skilled in the art.

As illustrated, a wireless terminal 350 comprises a client-side IWF 352, a TCP/IP protocol stack 354, and an application 356. Thus, in some embodiments of the present technology, communication between an application and an application server may be mediated by a pair of communicatively coupled IWFs.

As illustrated, a wireless terminal 360 comprises an optional TCP/IP protocol stack 364, and an application 366. Notably, the wireless terminal 360 does not include a client-side IWF. Rather, the application 366 communicates via SMS. The application 366 may further embed some TCP/IP header information into the SMS messages, as described elsewhere herein. Thus, in some embodiments of the present technology, communication between an application and an application server may be mediated by a single IWF.

As will be readily understandable to a worker skilled in the art, embodiments of the present technology may operate in communication network topologies other than illustrated above. For example, the application server may reside within the wireless communication network. As another example, the application server may be replaced by a wireless terminal residing in the same wireless communication network or a different wireless communication network.

### Intercepting Packets

Embodiments of the present technology comprise intercepting one or more packets generated by a communication process operating on the first device. The intercepted packets are formatted in accordance with a first protocol of the plurality of protocols.

Packet interception may be performed by a network node, such as an IWF or associated apparatus, which is placed along the path of packet transmission. Response packets and representative packets, as described below, may also be generated at this node. Or, if no generation is currently required (for example when the IWF is operating in a “null” mode), the response packets and representative packets can simply be forwarded by this node. In some embodiments, this network node apparatus resides on the same side of the wireless communication link as the device which generated the intercepted packets. In a further embodiment, the network node apparatus is integral to the device which generated the intercepted packets, or to the device which is the destination of the intercepted packets. This last embodiment is particularly applicable when the intercepted packets are generated by or addressed to a communication process operating in a wireless terminal, in which case the client-side IWF can also be integrally formed in the wireless terminal.

In some embodiments, where the network node apparatus is integral to the device, interception may be facilitated by internal device configuration. For example, all SMS messages received by a wireless terminal may be passed to the IWF for monitoring, to determine if any are to be further processed by the IWF or passed to another function, such as a user interface. Similarly, all TCP/IP packets may be passed through the IWF and intercepted thereby if predetermined conditions are satisfied.

In some embodiments, where the network node apparatus is external to the device, interception may be facilitated by network configuration. For example, all SMS messages passing through the wireless network may be passed to the IWF for monitoring, to determine if any are to be further processed by the IWF or passed to another network node. Similarly, all TCP/IP packets may be passed through the IWF and intercepted thereby if predetermined conditions are satisfied.

By intercepting packets prior to their traversal of the wireless communication link, embodiments of the present technology can represent these packets via an alternative protocol which makes more efficient use of wireless resources.

In some embodiments, for example when the IWF is operating in “null” mode, packets may not be intercepted, or they may be intercepted and immediately forwarded, thereby effectively eliminating interception.

In some embodiments, the communication process operating on the first device is a TCP/IP stack, which generates and transmits TCP packets for the first device, for example in response to commands by an application serviced by the TCP/IP stack.

In accordance with embodiments of the present technology interception of packets is performed at a first interface module of an associated apparatus. The first interface module may comprise standard network interface electronics hardware as would be readily understood by a worker skilled in the art.

### Responding to Intercepted Packets

Embodiments of the present technology comprise communicating one or more responses to the intercepted packets, if required. The responses are provided and/or formatted in accordance with the first protocol of the intercepted packets. Responses may include acknowledgement packets or other control packets required to maintain flow of packets via the first protocol.

Responding to the intercepted packets facilitates ongoing communication via the first protocol. For example, transmitting TCP acknowledgement (ACK) packets in response to packets received via the originating TCP protocol facilitates ongoing communication via TCP, which generally requires receipt of ACK packets.

In embodiments of the present technology, responding to intercepted packets comprises transmitting and receiving control packets, participating in handshakes, synchronization operations, connection closing operations, and the like, as is required by the first protocol. For example, if the first protocol is a TCP/IP protocol or an SMS protocol implementation for which acknowledgements are required, responding includes sending acknowledgement packets.

In some embodiments, by generating responses to intercepted packets at the point of interception, network resources can be conserved. For example, instead of transmitting all control packets and ACK packets back and forth across a wireless link, control packets can be received and responded to, and ACK packets can be generated and transmitted more locally.

In accordance with embodiments of the present technology, responding to intercepted packets is managed by an interworking function module of the associated apparatus, and the responses are communicated via the first interface module. The interworking function module may comprise standard electronic processing hardware, such as a CPU, executing program instructions stored in memory, along with electronic interface hardware for interfacing with the first and second interface modules, as would be readily understood by a worker skilled in the art.

### Representing Intercepted Packets

Embodiments of the present technology comprise communicating with the second device, or a representative thereof, in accordance with a second protocol selected from the plurality of protocols. Communication with the second device is representative of an intended communication corresponding to the one or more intercepted packets.

In embodiments of the present technology, representing intercepted packets comprises transmitting and receiving control packets, participating in handshakes, synchronization operations, connection closing operations, and the like, as is required by the second protocol. For example, if the second protocol is a TCP/IP protocol or an SMS protocol implementation for which acknowledgements are required, representing includes sending acknowledgement packets.

In accordance with embodiments of the present technology, representing the intercepted packets to the second device is managed by the interworking function module in conjunction with a second interface module, which operates as a network interface for communicating the managed representation. The second interface module may comprise standard network interface electronics hardware as would be readily understood by a worker skilled in the art.

In some embodiments, communication with the second device or the representative thereof, for purposes of representation, comprises one or more of: transmitting one or more control packets, transmitting one or more data packets, and receiving one or more control packets, and wherein the one or more data packets comprise a payload representative of a corresponding payload of the one or more intercepted packets.

### Second Protocol Selection

Some embodiments of the present technology comprise dynamic selection of the second protocol from a plurality of second protocols, in response to interception and/or analysis of the one or more packets. Dynamic selection may comprise selecting the most efficient, or otherwise most appropriate protocol, for a given communication and circumstance. Dynamic selection may be based at least in part on characteristics of the intercepted packets, such as packet lengths, packet length mean and variance, expected number of packets, inter-packet arrival time, and the like.

In some embodiments, the second protocol may be selected to be the same as the first protocol, if the first protocol is deemed most appropriate. For example, if a large TCP/IP packet is intercepted (the first protocol being TCP/IP), this packet may be too large for transmission via SMS (a potential second protocol). In this case, the IWF may be configured to use an implementation of TCP/IP over the wireless link (for example over GPRS or via other tunneling), to send the large packet.

In some embodiments, the second protocol may be selected to be different from the first protocol. For example, if the first protocol is TCP/IP, including a short data packet, the second protocol may be selected as SMS, as this requires fewer control packets (SYN, FIN and ACK packets) to be sent over the wireless link. A second IWF on the other side of the wireless link may be configured to transmit such control packets, if required.

In accordance with embodiments of the present technology, second protocol selection is managed by the interworking function module.

### First Use Case: Terminal-Initiated Communication

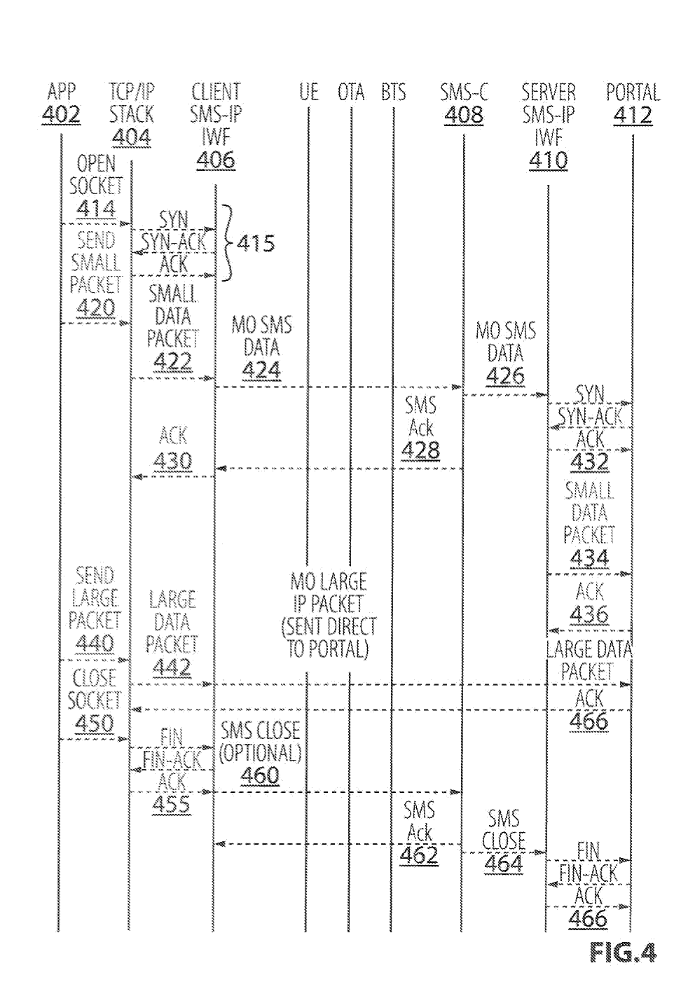

FIG. 4 illustrates an example message flow for a wireless terminal sending a small TCP packet and then a large TCP packet to a portal, such as an Internet portal. The portal connects via a TCP/IP network to an external server, such as an application server. An application running on the wireless terminal may thereby communicate with the application server.

As illustrated, an application 402 transmits an open socket command 414 to a TCP/IP stack 404. In response, the TCP/IP stack transmits packets in accordance with a synchronization operation 415. These packets are intercepted and responded to by a client-side SMS-IP IWF 406. Thus, the synchronization operation 415 is effectively performed between the TCP/IP stack and the client-side SMS-IP IWF. The synchronization operation synchronizes sequence numbers and signals the beginning of a TCP message flow, as would be readily understood by a worker skilled in the art. Since the SYN packet is not forwarded on by the client-side SMS-IP IWF, a SYN-ACK packet is generated by the client-side SMS-IP IWF. Communication between the TCP/IP stack 404 and the client-side SMS-IP IWF 406 is via TCP/IP packets. The application 402, TCP/IP stack 404 and client-side SMS-IP IWF 406 are integrated into the wireless terminal.

In some embodiments, the IWF and TCP stacks may be merged. In this case the SYN packets may not need to be generated.

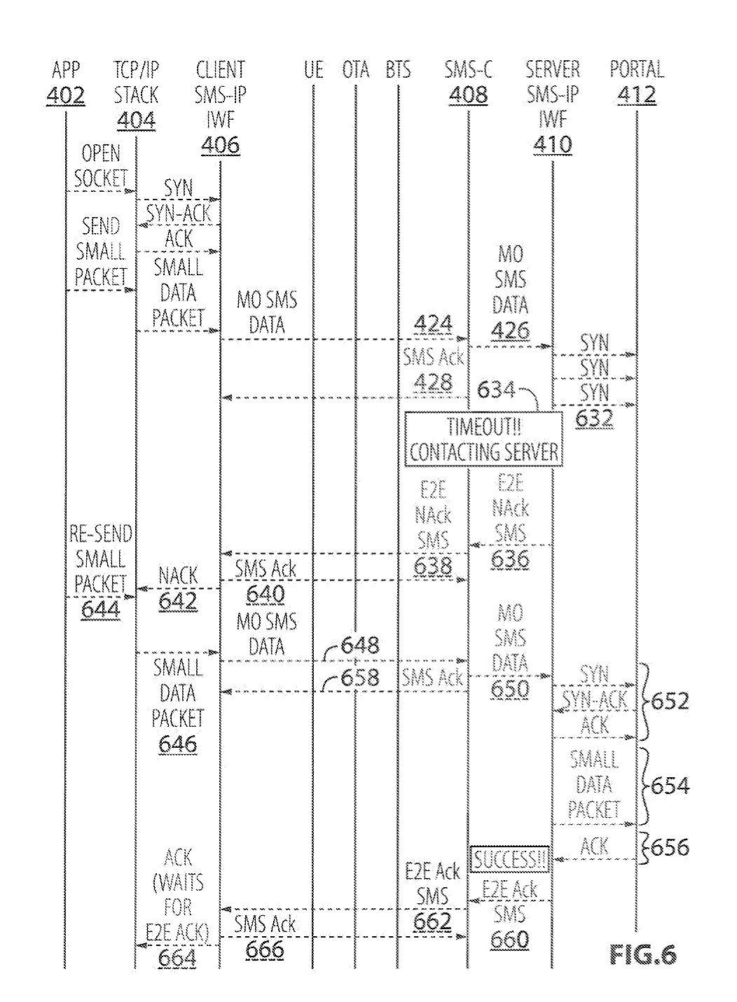

As further illustrated, the application 402 then initiates a command to the TCP/IP stack 404 to send 420 a small TCP/IP data packet. The command optionally includes the data to be embedded in the small data packet. The TCP/IP stack transmits the small data packet 422, which is again intercepted by the client-side SMS-IP IWF. Since the packet is small and not part of a large flow, the client-side SMS-IP IWF determines that it should be sent as an SMS message. The client-side SMS-IP IWF then extracts the data embedded in the small TCP/IP data packet and embeds this data, in a suitable format, into a mobile-originated (MO) SMS data message 424, which is sent via SMS to a short message service centre (SMS-C) 408 of the wireless network. In the present embodiment, the SMS-C generates an SMS message (SMS Ack) 428, acknowledging receipt of the MO SMS data message 424. Alternatively, the SMS-C may await acknowledgement that the data has been successfully received by the portal or even by an external application server before sending the SMS Ack 428. Upon receipt of the SMS Ack 428, the client-side SMS-IP IWF 406 generates a TCP/IP Ack packet 430 (with the sequence number of the small data packet 422) and transmits this to the TCP/IP stack 404 in accordance with the TCP protocol. The Ack packet 430 is indicative at least that the SMS-C has received the small data packet contents. Alternatively, as described below with respect to FIG. 6, the TCP Ack 430 can be deferred until confirmation of end-to-end packet delivery.

Substantially concurrently with sending the SMS Ack 428, the SMS-C forwards the MO SMS data message 424 as a forwarded message 426. The message 426 is intercepted by a server-side SMS-IP IWF 410. In response to the interception, the server-side SMS-IP IWF transmits TCP/IP packets to a portal 412 in accordance with a synchronization operation 432. The synchronization operation is prompted by interception of the message 426, since the TCP/IP protocol requires it for new connections. Following the synchronization operation 432, the server-side SMS-IP IWF extracts the data embedded in the message 426 and embeds this data, into a small TCP data packet 434, which is transmitted to the portal 412 and possibly forwarded from there to an application server. A TCP ACK 436 is transmitted to the server-side SMS-IP IWF in response, in accordance with the TCP protocol.

FIG. 4 further illustrates transmission of a large data packet following the small data packet. As illustrated the application 402 transmits a command 440 to the TCP/IP stack 404 to send a large data packet. The TCP/IP stack accordingly creates and transmits a large data packet 442 in TCP/IP format. Since the packet is too large for an SMS message, the client-side SMS-IP IWF may send it as a TCP/IP packet. In some embodiments, the wireless terminal may need to initially attach and open a PDP context when a large packet is to be sent, in order to enable the TCP/IP session. This is provided that a PDP context is not already open for that wireless terminal. The large data packet 442 is sent directly to the portal 412, generating a TCP ACK 444, which is sent to the TCP/IP stack 404, possibly forwarded via the client-side SMS-IP IWF 406.

The definition of a large packet may depend on Radio Access Technology (RAT) and Mobile Network Operator (MNO) policies. The client and/or server SMS-IP IWF may be configured to make decisions about how to send messages based on the packet size and frequency of packet transmissions. For example, if multiple short messages are presented for transmission in a short time, then the client and server IWF may use normal IP methods for transmission.

FIG. 4 further illustrates a TCP-based connection closing transaction, following transmission of the large data packet. As illustrated, the application 402 transmits a close socket command 450 to the TCP/IP stack 404. In response, the TCP/IP stack transmits packets in accordance with a finish operation 455. These packets are intercepted and responded to by a client-side SMS-IP IWF 406. Thus, the finish operation 455 is effectively performed between the TCP/IP stack and the client-side SMS-IP IWF. The finish operation affects a TCP/IP connection close, as would be readily understood by a worker skilled in the art. Since the FIN packet is not forwarded on by the client-side SMS-IP IWF, a FIN-ACK packet is generated by the client-side SMS-IP IWF. In response to the finish operation 455, the client-side SMS-IP IWF transmits, via SMS, an SMS close message 460 to the SMS-C 408. The SMS-C forwards this as a message 464, which is intercepted by the server-side SMS-IP IWF 410. An acknowledgement message 462 may also be sent to the client-side SMS-IP IWF in response, from the SMS-C or from the server-side SMS-IP IWF 410. The server-side SMS-IP IWF also responds to the SMS close message 464 by transmitting packets in accordance with a finish operation 466, in order to affect a TCP/IP connection close with the portal 412.

In some embodiments, if the client SMS-IP IWF detects that only small packets are to be sent, and that only one packet is sent per TCP session, then the server SMS-IP IWF may be configured to perform a TCP-based connection closing transaction, following reception and successful transmission of the small IP packet. This option saves having to wirelessly transmit the SMS close message, so that the client SMS-IP IWF does not need to send the SMS close packet which initiates the transmissions of packets in accordance with a finish operation 466, in order to affect a TCP/IP connection close with the portal 412.

Notably, as illustrated in FIG. 4, the TCP/IP stack 404 and the portal 412 communicate as if via TCP/IP, even though the two IWFs operate to translate messages to and from SMS format, and also generate various control packet responses. This is part of the transparency implemented by the client side and server side IWFs operating in combination.

### Second Use Case: Server-Initiated Communication

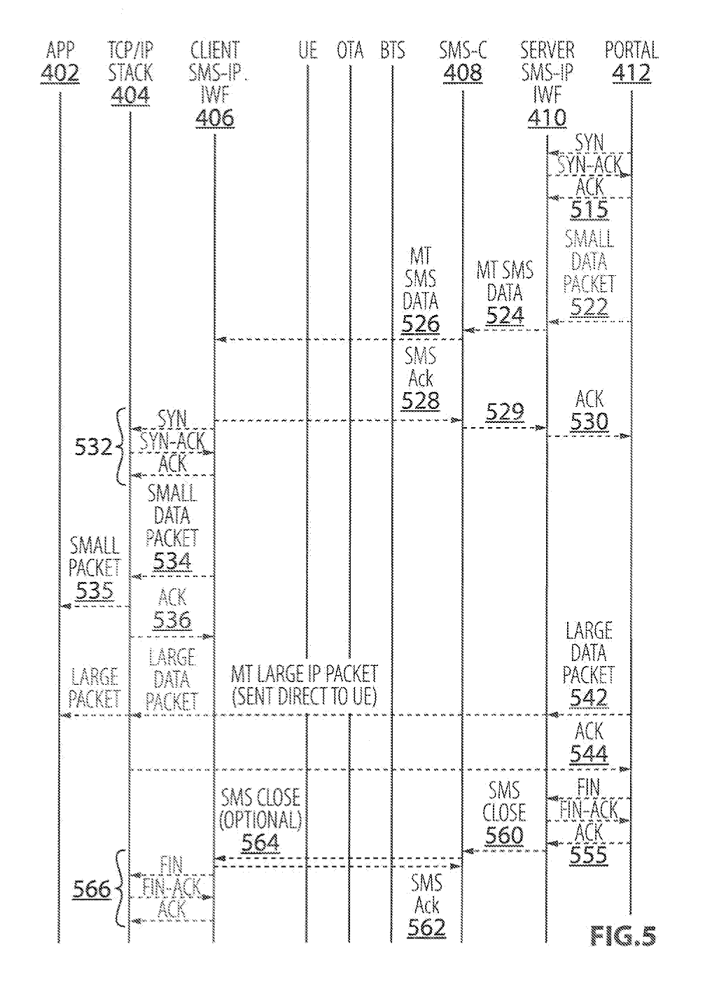

FIG. 5 illustrates an example message flow for a portal sending a small TCP packet and then a large TCP packet to a terminal. The portal connects via a TCP/IP network to an external server.

As illustrated, the portal 412 transmits packets in accordance with a synchronization operation 515. These packets are intercepted and responded to by the server-side SMS-IP IWF 410. Thus, the synchronization operation 515 is effectively performed between the portal and the server-side SMS-IP IWF. Since the SYN packet is not forwarded on by the server-side SMS-IP IWF, a SYN-ACK packet can be generated by the server-side SMS-IP IWF, without fear that the SYN-ACK is premature.

As further illustrated, the portal 412 transmits a small data packet 522, which is again intercepted by the server-side SMS-IP IWF 410. The small data packet 522 may have been forwarded by the portal 412 from an external application server. Since the packet is small and not part of a large flow, the server-side SMS-IP IWF determines that it should be sent as an SMS message. The server-side SMS-IP IWF then extracts the data embedded in the small TCP/IP data packet 522 and embeds this data, in a suitable format, into a mobile-terminated (MT) SMS data message 524, which is sent via SMS to a short message service centre (SMS-C) 408 of the wireless network.

The SMS-C forwards the MT SMS data message 524 to the appropriate wireless terminal as a forwarded message 526. The message 526 is intercepted by a client-side SMS-IP IWF 406. In response to the interception, the client-side SMS-IP IWF transmits TCP/IP packets to the TCP/IP stack 404 of the wireless terminal in accordance with a synchronization operation 532. Following the synchronization operation 532, the client-side SMS-IP IWF extracts the data embedded in the message 526 and embeds this data, into a small TCP data packet 534, which is transmitted to the TCP/IP stack 404, which extracts the data therein for forwarding as small packet data 535. A TCP ACK 536 is transmitted by the TCP/IP stack to the client-side SMS-IP IWF in response, in accordance with the TCP protocol.

In the present embodiment, the client-side SMS-IP IWF 406 generates an SMS message (SMS Ack) 528, acknowledging receipt of the MT SMS data message 526. The SMS-C forwards this as an acknowledgement 529 to the server-side SMS-IP IWF 410. Alternatively, the SMS-C may generate and send the acknowledgement 529 before the SMS Ack 528 is received, although this runs the risk of losing the packet. Upon receipt of the acknowledgement 529, the server-side SMS-IP IWF 410 generates a TCP/IP Ack packet 530 (with the sequence number of the small data packet 522) and transmits this to the portal 412 in accordance with the TCP protocol. The Ack packet 530 is indicative at least that the SMS Ack 529 has been received from the SMS-C for the successful delivery of the small data packet contents 522 to the client SMS-IP IWF 406.

FIG. 5 further illustrates transmission of a large data packet following the small data packet. As illustrated the portal 412 transmits a large data packet 542 in TCP/IP format. Since the packet is too large for an SMS message, the server-side SMS-IP IWF may intercept and then forward the large data packet 542 as a TCP/IP packet, instead of converting it to an SMS message. In some embodiments, the wireless terminal may need to attach and a PDP context may need to be opened when a large packet is to be sent, in order to enable the TCP/IP session. The large data packet 542 is sent, for example via TCP/IP operative with a user plane, to the application 402 running on the wireless terminal, and is received and handled by the TCP/IP stack 404. Receipt generates a TCP ACK 544 at the TCP/IP stack, which is sent by the TCP/IP stack 404 to the portal 412, possibly forwarded (substantially unchanged) via the client-side SMS-IP IWF 406 and/or the server-side SMS-IP IWF 410.

FIG. 5 further illustrates a TCP-based connection closing transaction, following transmission of the large data packet. As illustrated, the portal 412 transmits packets in accordance with a finish operation 555. These packets are intercepted and responded to by the server-side SMS-IP IWF 410. Thus, the finish operation 555 is effectively performed between the portal and the server-side SMS-IP IWF. Since the FIN packet is not forwarded on by the server-side SMS-IP IWF, a FIN-ACK packet is generated by the server-side SMS-IP IWF. In response to the finish operation 555, the server-side SMS-IP IWF transmits an SMS close message 560 to the SMS-C 408. The SMS-C may optionally forward this as an SMS message 564, which is intercepted by the client-side SMS-IP IWF 406. An acknowledgement message 562 may also be sent to the server-side SMS-IP IWF in response, from the client-side SMS-IP IWF. The client-side SMS-IP IWF also responds to the SMS close message 564 by transmitting packets in accordance with a finish operation 566, in order to affect a TCP/IP connection close with the TCP/IP Stack 404.

In some embodiments, an SMS-IP IWF may be configured to handle multiple open TCP sockets. For example, the TCP port number associated with each socket may be used to identify its corresponding socket. This port number may then be used to manage the state of each connection.

In embodiments of the present technology, dropped packets between the server SMS-IP IWF and the portal are handled using native protocol (e.g. TCP) procedures.

### Third Use Case: Failed Delivery of Terminal-Initiated Communication

In embodiments of the present technology, failed delivery of an SMS message to the server can be handled in one of a variety of ways. For example, if the server-side SMS-IP IWF cannot deliver the packet to its associated target (e.g. external Internet server), the server-side SMS-IP IWF can; store and try again later (assuming the application does not care about time of delivery), drop the packet (assuming the application does need to know if the packet is lost), or send a message back to the wireless terminal that the packet was not delivered in a timely manner.

FIG. 6 illustrates this last option, where the TCP ACK is not sent to the client's TCP stack until the end-to-end (E2E) SMS ACK is received by the SMS-IP IWF. Both the failure and success cases for delivery are shown.

As illustrated, the SMS-C 408 transmits the MO SMS data packet 424 as a forwarded message 426 to the server-side SMS-IP IWF 410, as described above with respect to FIG. 4. The SMS-C 408 also generates and transmits an SMS message (SMS ACK) 428 to the wireless terminal, acknowledging receipt of the MO SMS data message 424. Notably, the client-side SMS-IP IWF 406 does not transmit a TCP ACK packet to the TCP/IP stack 404 in response to the SMS ACK 428, but rather waits for end-to-end acknowledgement, as described below. Substantially concurrently, in response to the forwarded message 426, the server-side SMS-IP IWF 410 transmits and retransmits TCP/IP SYN packets to the portal 412 in accordance with a failed synchronization operation 632. The operation 632 fails in part because no acknowledgement is sent by the portal 412.

The failed synchronization operation 632 results in a TCP/IP timeout event 634 at the server-side SMS-IP IWF 410. In response, the server-side SMS-IP IWF 410 is configured to transmit an end-to-end negative acknowledgement (NACK) 636. This is forwarded as an SMS NACK message 638 by the SMS-C 408 and intercepted by the client-side SMS-IP IWF 406. At this point, the client-side SMS-IP IWF 406 generates and transmits a TCP NACK 642 to the TCP/IP Stack 404, triggering retransmission of the small data packet, as would be readily understood by a worker skilled in the art.

Specifically, the application 402 initiates a command to the TCP/IP stack 404 to re-send 644 a small TCP/IP data packet. The TCP/IP stack transmits the small data packet 646, which is again intercepted by the client-side SMS-IP IWF 406. The client-side SMS-IP IWF then extracts the data embedded in the small TCP/IP data packet and embeds this data, in a suitable format, into a mobile-originated (MO) SMS data message 648, which is sent via SMS to a short message service centre (SMS-C) 408 of the wireless network. Alternatively, the prior MO SMS data message 424 may be retrieved from a cache and re-sent as message 648. The SMS-C may then generate an SMS message (SMS ACK) 658, acknowledging receipt of the MO SMS data message 648.

Substantially concurrently with sending the SMS ACK 658, the SMS-C forwards the MO SMS data message 648 as a forwarded message 650. The message 650 is intercepted by a server-side SMS-IP IWF 410. In response to the interception, the server-side SMS-IP IWF transmits TCP/IP packets to a portal 412 in accordance with a synchronization operation 652. Following the synchronization operation 652, the server-side SMS-IP IWF extracts the data embedded in the message 650 and embeds this data, into a small TCP data packet 654, which is transmitted to the portal 412 and possibly forwarded from there to an application server. A TCP ACK 656 is transmitted to the server-side SMS-IP IWF in response, in accordance with the TCP protocol.

The TCP ACK 656 triggers the server-side. SMS-IP IWF 410 to transmit an end-to-end acknowledgement message 660 to the SMS-C 408, for example as an SMS message. The acknowledgement message 660 is forwarded as an end-to-end acknowledgement SMS 662 by the SMS-C. The client-side SMS-IP IWF 406 generates an end-to-end TCP ACK 664 which is sent to the TCP/IP stack 404, thereby acknowledging packet receipt. Substantially concurrently, an acknowledgement of the SMS message 666 may be transmitted by the client-side SMS-IP IWF 406 to the SMS-C 408.

Alternatively, the SMS-C can be configured not to send the SMS ACK 428 immediately. This avoids requiring both a SMS-C originated acknowledgement and an end-to-end acknowledgement of packet delivery.

### Fourth Use Case: Server-Side IWF Only

In some embodiments, a server SMS-IP IWF is provided for use without a corresponding client SMS-IP IWF. In such embodiments, an application running on the wireless terminal may need to embed some IP header and TCP information into the body of SMS messages communicated therefrom. The application may also need to have additional intelligence (for example processing routines and triggers) in order to adequately process the SMS messages and interoperate with the server SMS-IP IWF. One advantage of dispensing with the client SMS-IP IWF is that, for the terminal-initiated communication case, the device's application could make the decision of when to use SMS and when to go directly to TCP for larger transfer.

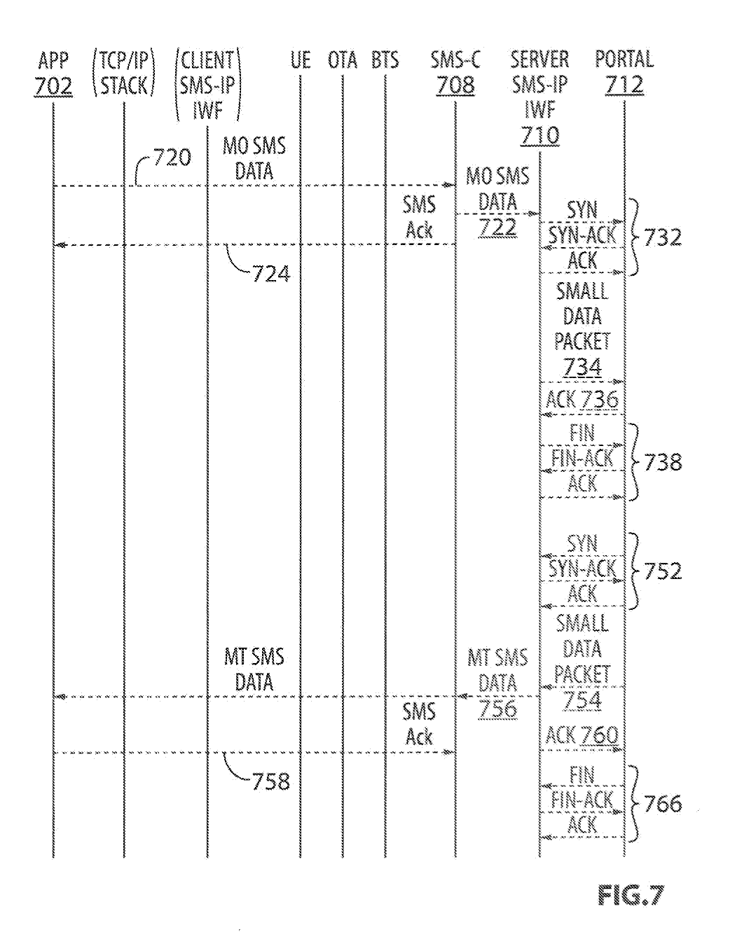

FIG. 7 illustrates example message flows from and to a wireless terminal, when no client-side SMS-IP IWF is present or currently being used (a client-side SMS-IP IWF and TCP/IP Stack may be present but currently unused). For messages from the wireless terminal, the application 702 operating on the mobile terminal generates and transmits a mobile-originated SMS data message 720 to an SMS-C 708. The SMS-C forwards the MO SMS data message as a message 722, which is intercepted by the server-side SMS-IP IWF 710. The SMS-C may also transmit an acknowledgement 724 to the wireless terminal.

In response to the message 722, the server-side SMS-IP IWF 710 transmits TCP/IP packets to a portal 712 in accordance with a synchronization operation 732. Following the synchronization operation 732, the server-side SMS-IP IWF transmits a small TCP data packet 734, comprising the small data packet payload, to the portal 712 and possibly forwarded from there to an application server. A TCP ACK 736 is transmitted and intercepted by the server-side SMS-IP IWF in response, in accordance with the TCP protocol. In response to the TCP ACK 736, the server-side SMS-IP IWF transmits packets in accordance with a finish operation 738, in order to affect a TCP/IP connection close with the portal 712.

For messages initiated by the portal 712, the portal 712 transmits TCP/IP packets in accordance with a synchronization operation 752. These packets are intercepted and responded to by the server-side SMS-IP IWF 710. The portal 712 then sends a small TCP data packet 754, which is again intercepted by the server-side SMS-IP IWF 710. The server-side SMS-IP IWF extracts the payload of the small TCP data packet 754 and embeds same into a mobile-terminated SMS data message 756 which is transmitted, via the SMS-C 708 to the mobile terminal and received by the application 702 thereof. The application may also transmit an SMS acknowledgement 758 to the SMS-C. The server-side SMS-IP IWF 710 also transmits a TCP acknowledgement 760 to the portal 712, acknowledging receipt of the small data packet 754 in accordance with the TCP/IP protocol. In response to the TCP ACK 760, the portal transmits packets in accordance with a finish operation 766, in order to effect a TCP/IP connection close. The server-side SMS-IP IWF 710 intercepts and responds to these packets in order to affect the connection close.

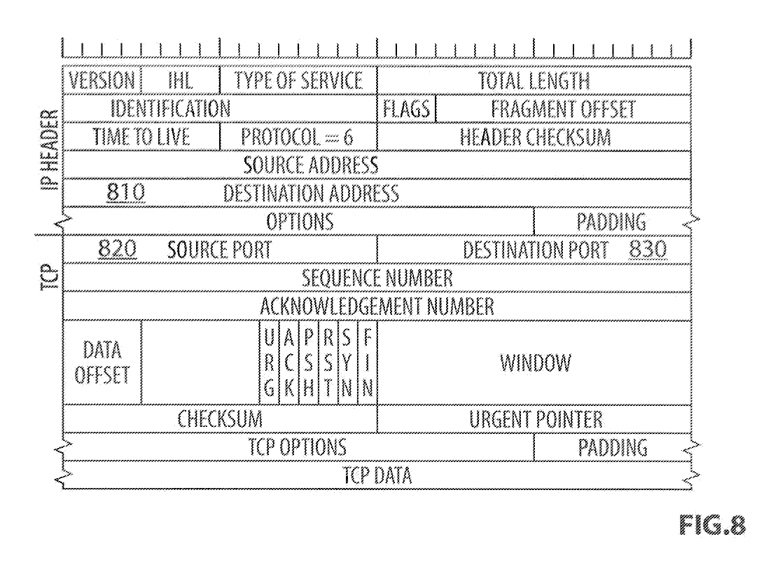

As mentioned above, when no client SMS-IP IWF is present, some TCP/IP header information may need to be contained, in a predetermined format, within the body of the SMS messages. The corresponding server SMS-IP IWF is also configured to extract the header information provided in this format. FIG. 8 illustrates a diagram of a TCP/IP header. The marked items 810, 820, 830 are items which are embedded in the body of SMS messages sent by the terminal in this situation. Item 810 corresponds to the IP Source Address, Item 820 corresponds to the TCP Source Port, and Item 830 corresponds to the TCP Destination Port. The remaining fields may be determined or assigned by the Server SMS-IP IWF.

### Potential Variations Accommodating a NAT

In various embodiments, a NAT is present which operates on packets such as TCP/IP data packets which are to be intercepted by an IWF as described herein. As used herein, a NAT (network address translator) may perform network address translation, port address translation, or both. For example, a NAT may be placed between the base transceiver station (BTS) and the server-side SMS-IP IWF. Depending on placement of the NAT, the IWF may require modification in order to ensure it cooperates appropriately with the NAT. Alternatively, for a NAT placed between the server-side SMS-IP IWF and the portal, the IWF may continue to operate substantially as described in the above use cases.

As mentioned above, in some embodiments a NAT may be placed between the BTS and the server-side SMS-IP IWF. This may be the case for example when the server-side SMS-IP IWF is placed outside of a mobile network operator domain. In this case, the client device (for example a mobile device or user equipment) may be assigned a local IP address while the server-side SMS-IP IWF may require a public IP address so that it can send IP packets to the portal. To address this, the server-side SMS-IP IWF may be closely integrated with the NAT. For example, the server-side SMS-IP IWF may be configured to also provide the NAT functionality, for example by assigning a public IP address and appropriate port number and perform translation for incoming packets.

Referring back to FIG. 4, if a NAT is provided between the BTS and the server-side SMS-IP IWF 410, then the header of the large data packet 442 would be altered by the NAT. However, the data packet 442 bypasses the server-side SMS-IP IWF 410. If the server-side SMS-IP IWF is required to generate TCP/IP packets to transmit to the portal, such as packets 432 and 434, it is desirable that it use the same header information as in the packet 442 in order to preserve session continuity. Integration of the server-side SMS-IP IWF and the NAT may address this.

For example, in one embodiment, the server-side SMS-IP IWF 410 comprises the NAT, so that the large data packet 442 traverses the NAT portion of the IWF 410. Thus, the server-side SMS-IP IWF 410 can apply the same NAT/PAT mappings to the large data packet 442 as previously applied to packets 432 and 434. The server-side SMS-IP IWF 410 may further be configured to identify which IP flow the arriving large data packet belongs to 442. To accomplish this, firstly, when the first MO SMS message 426 is received for that IP flow, the server-side SMS-IP IWF 410 may be configured to store the source IP address, destination IP address, and port numbers specified in the synchronization operation 415, to uniquely identify the associated IP flow.

Then, at least for the initial large IP packet (the packet that makes the hole through the NAT and setups the bindings in the NAT), the client-side SMS-IP IWF 406 may append at least the source IP address and source port number to the large packet. It is noted that the source IP address and source port number combination may not be unique if the server-side SMS-IP IWF 410 is serving more than one LAN. Thus, if a large data packet is to be sent with capability to use the IWF for smaller packets in the same session, a small part of the very first part of the data may be sent first by SMS in order to set up the correspondence that will link the SMS and the IP as belonging to the same session. In one embodiment, if it is not known at the outset whether both mechanisms will be needed in a session then a default policy is set up to send an SMS first.

Referring back to FIG. 5, if a NAT is in place, then a mechanism may be provided to establish a binding prior to handling of the large data packet 542. Conventionally, as will be readily understood by a worker skilled in the art, without a binding or “hole” established at the NAT due to the client having previously transmitted a TCP/IP message to the portal, the NAT would reject the large data packet 542. In one embodiment, in order to establish such a binding, client-side SMS-IP IWF 406 may be configured to first send a packet through the NAT to the server-side SMS-IP IWF 410 to establish the appropriate NAT binding, for example following receipt of the SMS packet 526. The “hole punch” packet which establishes the NAT binding may contain the source IP address and source port number which may be registered by the server-side SMS-IP IWF 410 and used for future identification of the IP packet flow. The server-side SMS-IP IWF 410 may be configured to transmit an SMS control packet to the client device for processing by the client-side SMS-IP IWF 406. The control packet may indicate when to send the hole punch packet. Alternatively, the client-side SMS-IP IWF 406 may be configured, by default, to send a hole punch packet when a new IP flow is started. Large IP packets transmitted toward the client may then be routed through the server-side. SMS-IP IWF 410. The server-side SMS-IP IWF 410 may further be configured to apply the correct NAT/PAT mappings and send modified packet to the NAT.

### MSISDN Assignment

As will be readily understood by a worker skilled in the art, SMS messages may be addressed to their destination using MSISDNs. Thus, in embodiments of the present technology, building an SMS message comprises determining at least the destination MSISDN. The destination MSISDN may be correlated, for example, with a corresponding destination IP address and destination port number of a TCP/IP packet which the SMS message is based on. More generally, when a packet formatted in accordance with a first protocol is intercepted and a representative packet formatted in accordance with a second protocol is generated, the representative packet may be addressed based at least in part on the address contained in the first packet and other known or discoverable information.

In some embodiments, for an SMS message generated by the client-side SMS-IP IWF, the destination MSISDN is associated with the server-side SMS-IP IWF. This destination MSISDN may be provided to the client device, for example via OMA-DM or at the time of manufacturing and is used as a generic address for various TCP/IP flows. If there are several server-side SMS-IP IWF's, each client device may be provided with a plurality of different server-side SMS-IP IWF MSISDN's which SMS messages may be addressed to, in order for example to spread the load across plural server-side SMS-IP IWF's. Optionally, a URI may be stored in the client device which can then be translated to the MSISDN of a corresponding server-side SMS-IP IWF, for example via a DNS. This allows a more dynamic assignment of server-side SMS-IP IWF numbers at the client device.

In some embodiments, for an SMS message generated by the server-side SMS-IP IWF, the server-side SMS-IP IWF may only have access to the destination IP address in the TCP/IP packet which the SMS message is to represent. A translation from the destination IP address to the client's MSISDN number may thus be performed. Two approaches for performing such a translation according to embodiments of the present technology are detailed below.

The first approach pertains to a scenario in which the destination client device has a publicly routable IP address and proceeds as follows. Referring again to FIG. 4, when the server-side SMS-IP IWF 410 receives the first MO SMS 426, the server-side SMS-IP IWF stores the source MSISDN identified in that SMS and the associated public IP header information (source and destination port addresses and port numbers), which may optionally be generated by the server-side SMS-IP IWF, for example on demand. Then in the future if the server-side SMS-IP IWF receives a small IP packet from the portal 412 with matching IP flow information, it is configured to use the stored MSISDN, retrieved for example via a look-up table operation, in generating a SMS message representative of the small IP packet.

Referring again to FIG. 5, when the packets associated with the synchronization operation 515 arrive at the server-side SMS-IP IWF 410, the server-side SMS-IP IWF checks to see whether or not the header information is associated with an existing flow, for example by determining whether or not the destination IP address is currently associated with an existing flow. If there is no current association, the server-side SMS-IP IWF may not currently have a means to map the destination IP address to an appropriate MSISDN of the destination client device. In this case, it may not be possible initially to send a representative SMS message such as message 524. In this case the small data packet 522 may be forwarded to the client-side device, for example to the client-side SMS-IP IWF 406, via TCP/IP. Upon receipt, the client-side SMS-IP IWF may transmit the client device MSISDN to the server-side SMS-IP IWF, for example by appending same to a TCP/IP acknowledgement packet generated in response to the forwarded small data packet 522. The server-side SMS-IP IWF can read the client MSISDN and associate it with the TCP header information for future use. Subsequent TCP/IP packets received by the server-side SMS-IP IWF from the portal may then be optionally represented by SMS messages in accordance with the present technology, by reading the TCP/IP packet header and using the associated MSISDN stored in memory at the server-side SMS-IP IWF. Alternatively, when the client device obtains its public IP address from the network, the client-side SMS-IP IWF 406 may be configured to automatically register the correlation between this IP address and its MSISDN with the server-side SMS-IP IWF, for example via an SMS or IP message. The less often the public IP address changes, the less often the mapping needs to be set up at the server-side SMS-IP IWF. For this reason, static or quasi-static assignment of public IP addresses may be beneficial, although not required.

The second approach pertains to a scenario in which the destination client device has a local IP address (for example used in conjunction with a NAT for communication with the broader public network). In this case, the same solution as described with respect to FIG. 4 above may be applied, except with a local IP address instead of a public IP address in use. Referring to FIG. 5, another solution may be required, since neither the portal nor the server-side SMS-IP IWF would be expected to have a publicly routable destination IP address to send to. In this case, the client-side SMS-IP IWF may be configured to first send a hole punch TCP/IP packet through the NAT to the server-side SMS-IP IWF in order to establish the appropriate NAT binding. This uplink packet would typically contain the source IP address and source port number so that the server-side SMS-IP IWF could register same in order to identify the associated IP flow. The server-side SMS-IP IWF may further be configured to indicate via an SMS control packet to the client, for interpretation by the client-side SMS-IP IWF when to send this hole punch packet. Alternatively, the client-side SMS-IP IWF may be configured to send the hole punch message by default when a new IP flow is started. The large downlink packets such as packet 542 may then be routed through the server-side SMS-IP IWF, which may also apply the correct NAT/PAT mappings and/or send the modified packet to the NAT.

In some embodiments, the SRC port is only required to identify the multiple simultaneous TCP flows. If this is not required, the SRC port can be filled-in by the IWF.

In some embodiments, the SRC IP address can be chosen by the IWF (similar to a NAT) where SRC MSISDN of incoming SMS can be used to keep the binding. There needs to be a pool of IP addresses that the SMS-IP IWF could use.

In some embodiments, the IWF may generate Seq and ACK numbers in the same manner as a TCP stack starting a transaction.

In some embodiments, an SMS-IP IWF may be configured to convert SMS to and/or from UDP packets. A benefit of this configuration is that there are no SYN, ACK, FIN packets to handle. This may provide a simpler implementation over TCP, but without the connection-oriented benefits accomplished by TCP.

In embodiments of the present technology, since HTTP is normally sent on top of TCP, embodiments of the present technology which support TCP communication would also inherently support HTTP communication.

In some embodiments, when a wireless terminal roams to another location or network, the SMS-IP Interworking function may optionally be provided in the visited network. This would enable large and small packets to be routed via IP to and from the terminal at its roaming location.

It will be appreciated that, although specific embodiments have been described herein for purposes of illustration, various modifications may be made without departing from the scope of the technology. In particular, it is within the scope of the technology to provide a computer program product or program element, or a program storage or memory device such as a non-transitory storage medium, magnetic or optical wire, tape or disc, or the like, for storing signals readable by a machine, for controlling the operation of a computer according to the method of the technology and/or to structure its components in accordance with the system of the technology.

Further, each step of the methods may be executed on a general computer, such as a personal computer, server or the like and pursuant to one or more, or a part of one or more, program elements, modules or objects generated from any programming language, such as C, C++, Java, Perl, PL/1, or the like. In addition, each step, or a file or object or the like implementing each said step, may be executed by special purpose hardware or a circuit module designed for that purpose.

It is obvious that the foregoing embodiments of the technology are examples and can be varied in many ways. Such present or future variations are not to be regarded as a departure from the scope of the technology, and all such modifications as would be obvious to one skilled in the art are intended to be included within the scope of the following claims.

We claim:

1. A method for facilitating data communication between a first device and a second device, the first device and the second device communicatively coupled at least in part via a wireless communication link, wherein the wireless communication link is capable of supporting said data communication via a plurality of protocols, the method implemented by one or more computing devices and comprising:
a.) intercepting one or more packets generated by a communication process operating on the first device, the packets formatted in accordance with a first protocol of the plurality of protocols;
b.) communicating one or more responses to one or more intercepted packets, if required, in accordance with the first protocol; and
c.) communicating with the second device or a representative thereof in accordance with a second protocol selected from the plurality of protocols, wherein said communication with the second device is representative of an intended communication corresponding to the one or more intercepted packets.

2. The method according to claim 1, wherein the first protocol is a TCP/IP protocol, and wherein the second protocol is an efficient small message protocol.

3. The method according to claim 1, wherein said communication with the second device or the representative thereof comprises one or more of: transmitting one or more control packets, transmitting one or more data packets, and receiving one or more control packets, and wherein the one or more data packets comprise a payload representative of a corresponding payload of the one or more intercepted packets.

4. The method according to claim 1, further comprising selecting the second protocol from the plurality of protocols in response to interception of the one or more packets.

5. The method according to claim 4, wherein selecting the second protocol is based at least in part on characteristics of the one or more intercepted packets.

6. The method according to claim 4, wherein the second protocol is selected from the group comprising: the first protocol and an alternate protocol.

7. The method according to claim 4, wherein the second protocol is selected based at least in part to facilitate increased communication efficiency relative to at least the first protocol.

8. The method according to claim 1, wherein the packets are intercepted at a first location prior to traversal of the wireless communication link by the one or more intercepted packets, and wherein said communication with the second device comprises communication over the wireless communication link in accordance with the second protocol.

9. The method according to claim 8, wherein the one or more responses are generated at the first location for communication to the communication process, and wherein the one or more transmitted control packets and the one or more transmitted data packets are generated at the first location.

10. The method according to claim 1, wherein the second protocol is selected dynamically.

11. The method according to claim 1, wherein the representative is configured to convert the communication in accordance with the second protocol to a further communication, the further communication configured in accordance with the first protocol and presented to the second device.

12. The method according to claim 1, wherein the one or more responses comprise an acknowledgement, the acknowledgement transmitted upon receipt of a corresponding acknowledgement from the second device or the representative thereof, thereby facilitating end-to-end connectivity between the first device and the second device.

13. An apparatus configured to facilitate data communication between a first device and a second device, the first device and the second device communicatively coupled at least in part via a wireless communication link, wherein the wireless communication link is capable of supporting said data communication via a plurality of protocols, the apparatus comprising:
a.) a first interface module configured to intercept one or more packets generated by a communication process operating on the first device, the packets formatted in accordance with a first protocol of the plurality of protocols;
b.) a second interface module configured for communication with the second device or a representative thereof; and
c.) an interworking function module configured to:
i.) manage communication of one or more responses to the one or more intercepted packets, if required, in accordance with the first protocol, the one or more responses communicated via the first interface module; and
ii.) manage communication with the second device or the representative thereof in accordance with a second protocol selected from the plurality of protocols, wherein said communication with the second device or the representative thereof is representative of an intended communication corresponding to the one or more intercepted packets, said communication with the second device performed via the second interface module.

14. The apparatus according to claim 13, wherein the apparatus resides on the same side of the wireless communication link as the first device.

15. The apparatus according to claim 13, wherein the apparatus is integral to the first device.

16. The apparatus according to claim 13, wherein the apparatus appears as a communication endpoint to one or both of the first device and the second device.

17. The apparatus according to claim 13, wherein the apparatus is transparent to communication between the first device and the second device.

18. A system comprising an apparatus as described in claim 13 and a second apparatus configured as the representative of the second device, wherein the second apparatus is configured to intercept and convert said communication with the second device to a further communication, the further communication configured in accordance with the first protocol and presented to the second device.

19. A computer program product comprising a computer readable memory storing computer executable instructions thereon that when executed by one or more operatively coupled computers, perform operations for facilitating data communication between a first device and a second device, the first device and the second device communicatively coupled at least in part via a wireless communication link, wherein the wireless communication link is capable of supporting said data communication via a plurality of protocols, the operations comprising:
a.) intercepting one or more packets generated by a communication process operating on the first device, the packets formatted in accordance with a first protocol of the plurality of protocols;
b.) communicating one or more responses to one or more intercepted packets, if required, in accordance with the first protocol; and
c.) communicating with the second device or a representative thereof in accordance with a second protocol selected from the plurality of protocols, wherein said communication with the second device is representative of an intended communication corresponding to the one or more intercepted packets.

20. A method for facilitating data communication between a first device and a second device, the first device and the second device communicatively coupled at least in part via a wireless communication link, wherein the wireless communication link is capable of supporting said data communication via a first protocol and a second protocol, the method implemented using one or more computing devices and comprising:
a.) intercepting one or more packets generated by a communication process operating on the first device, the packets formatted in accordance with the first protocol, the packets intercepted at a first location prior to traversal of the wireless communication link;
b.) generating, at the first location and in response to the one or more intercepted packets, one or more response packets in accordance with the first protocol;
c.) communicating the one or more response packets to the communication process;
d.) generating, at the first location and in response to the intercepted packets, one or more representative packets in accordance with the second protocol, the representative packets comprising content corresponding to content of the intercepted packets; and
e.) transmitting the representative packets via the wireless communication link, the representative packets addressed to the second device.
